(19) United States
(12) Patent Application Publication
(10) Pub. No.: US 2004/0104870 A1
(43) Pub. Date: Jun. 3, 2004

(54) Display device and method of driving the same

(76) Inventor: Koji Mametsuka, Ageo-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/716,499

(22) Filed: Nov. 20, 2003

(30) Foreign Application Priority Data
Nov. 21, 2002 (JP) 2002-338040

(51) Int. Cl. G09G 3/30

(52) U.S. Cl. 345/76

(57) ABSTRACT

A display device includes an organic EL panel having a plurality of pixels arrayed in a matrix. Each pixel includes an organic EL element, a drive control element that causes a current to flow in the organic EL element according to a pixel video signal, a capacitor, which is connected to a control terminal of the drive control element, and that temporarily stores the potential difference between the threshold voltage of the drive control element and a reset signal, and a pixel switch connected via the capacitor to the control terminal of the drive control element. In particular, the display device includes a reset signal supply section that supplies to the pixels different reset signals associated with the main wavelengths of light to be emitted from the organic EL elements.

### CROSS-REFERENCE TO RELATED APPLICATIONS

This application is based upon and claims the benefit of priority from the prior Japanese Patent Application No. 2002-338040, filed Nov. 21, 2002, the entire contents of which are incorporated herein by reference.

### BACKGROUND OF THE INVENTION

1. Field of the Invention

The present invention relates to a display device including a plurality of pixels formed using self-luminous elements such as organic EL (electro luminescent) elements, and to a display device in which a plurality of self-luminous elements that emit red, green and blue light are associated for color display, for example.

2. Description of the Related Art

Flat-panel display devices are widely used for personal computers, portable information terminals and TVs. In recent years, attention has been paid to flat-panel display devices that employ self-luminous elements such as organic EL elements, and active research and development of such display devices has been pursued. An organic EL display device has the advantage that does not employ a backlight undesired for reduction in thickness and weight, is suited to the reproduction of moving images owing to its high-speed response, and is usable in a cold place because the luminance is not decreased by a low temperature.

In general terms, an organic EL display device includes a matrix of pixels each using an organic EL element that emits light at a luminance corresponding to the current supplied thereto, and a driving circuit connected to the pixels via a plurality of pixel switches. When digital pixel video signals are supplied in series from an external signal source to the driving circuit, the driving circuit converts the digital pixel video signals for pixels in one row to analog pixel video signals using a predetermined number of gradation reference signals, and outputs the converted analog pixel video signals in parallel. The pixels of each row are driven according to the analog pixel video signals that are output in parallel from the driving circuit and captured by the pixel switches of a corresponding row.

Each pixel includes an organic EL element, which is a self-luminous elements a drive control element composed of a thin-film transistor connected in series with the organic EL element between a pair of power supply terminals, and a capacitance element that stores a control voltage for the drive control element. The drive control element causes a drive current to flow in the organic EL element according to an analog pixel video signal supplied from a corresponding pixel switch as the control voltage.

In the case where the organic EL display device is designed for color display, a set of organic EL elements for red (R), green (G) and blue (B), for instance, serves as a color pixel. In general, the luminance characteristics, e.g., the current-luminance characteristics, of the three organic EL elements are different from one another. Conventionally, a predetermined number of red gradation reference signals, a predetermined number of green gradation reference signals, and a predetermined number of blue gradation reference signals are provided in order to obtain red, green and blue light properly balanced in luminance for white display. The red, green, and blue gradation reference signals are set in different voltage ranges and selectively used to convert digital pixel video signals to analog pixel video signals.

However, even in the case of color display, it is preferable that a predetermined number of gradation reference signals are commonly applicable to the organic EL elements for red, green and blue.

The thin-film transistors used as the drive control elements for driving the organic EL elements are formed by using semiconductor thin films disposed on an insulating substrate of glass, etc. Consequently, the characteristics of these thin-film transistors, such as the threshold voltage Vth and carrier mobility μ, are inferior to those of transistors formed on a silicon substrate. In addition, a significant variation occurs in each characteristic due to the manufacturing process. If the threshold voltages Vth of the drive control elements differ from each other, it is difficult for the organic EL elements to emit light with proper luminances. In such a case, a desired white chromaticity cannot be obtained because of the imbalance in luminance between the organic EL elements. Further, in the case where the three kinds of organic EL elements have different characteristics caused by the manufacturing process, an imbalance in luminance occurs between the organic EL elements and makes it difficult to obtain the desired white chromaticity. In short, in the prior-art organic EL display device, the color display quality is affected by the manufacturing process and so easily deteriorates.

### BRIEF SUMMARY OF THE INVENTION

The present invention has been made in consideration of the above circumstances, and its object is to provide a display device in which deterioration in color display quality caused by the manufacturing process can be reduced without requiring a complex structure, and to a method of driving the display device.

According to a first aspect of the present invention, there is provided a display device comprising: an array section having a plurality of pixels arrayed in a matrix, each pixel including a luminous element, a drive control element that causes a current to flow in the luminous element according to a pixel video signal, a capacitor, which is connected to a control terminal of the drive control element, and that temporarily stores the potential difference between the threshold voltage of the drive control element and a reset signal, and a pixel switch connected via the capacitor to the control terminal of the drive control element; and a reset signal supply section that supplies to the pixels different reset signals associated with the main wavelengths of light to be emitted from the luminous elements.

According to a second aspect of the present invention, there is provided a method of driving a display device including a plurality of pixels, each pixel including a luminous element, a drive control element connected in series with the luminous element and a pixel switch connected via a capacitor to a control terminal of the drive control element, comprising: applying a potential equal to the threshold voltage of the drive control element to one of the electrodes of the capacitor; supplying to the other electrode of the capacitor a reset signal associated with the main wavelength of light to be emitted from the luminous element; and supplying a pixel video signal to the other electrode of the capacitor via the pixel switch, in a state where the capacitor stores the potential difference between the reset signal and the threshold voltage.

In the display device and the driving method, it is possible to define the luminance balance between luminous elements by means of the mutual relationship between reset signals. Thus, digital-to-analog conversion of the pixel video signals for the luminous elements can be performed using a predetermined number of gradation reference voltages provided commonly for the luminous elements. Moreover, even if there is a variation in the threshold voltage of each drive control element, the control voltage for each drive control element is initialized to a level equal to the inherent threshold voltage of the drive control element, prior to capturing the pixel video signal. Thereby, proper luminance not adversely affected by variation in threshold voltage can be obtained in each luminous element. In this case, since the luminance balance between the luminous elements is not lost, a desired white chromaticity can be obtained.

Therefore, deterioration in color display quality caused by the manufacturing process can be reduced without requiring a complex structure.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the circuit configuration of an organic EL display device according to a first embodiment of the present invention;

FIG. 2 is a diagram showing an equivalent circuit of each pixel PX shown in FIG. 1;

FIG. 3 is a diagram showing the configuration of a driver IC and a signal line driving circuit shown in FIG. 1;

FIG. 4 is a diagram showing an example of the configuration of a gradation reference circuit shown in FIG. 3;

FIG. 5 is a time chart illustrating signal waveforms generated during the operation of the organic EL display device shown in FIG. 1;

FIG. 6 is a diagram showing the circuit configuration of an organic EL display device according to a second embodiment of the present invention;

FIG. 7 is a diagram showing the circuit configuration of an organic EL display device according to a third embodiment of the present invention;

FIG. 8A to FIG. 8C are graphs for explaining a specific example of adjustment of the luminance balance in the organic EL display device shown in FIG. 7;

FIG. 9 is a diagram showing the circuit configuration of an organic EL display device according to a fourth embodiment of the present invention; and

FIG. 10 is a diagram showing the circuit configuration of a gradation reference circuit included in a DC/DC converter shown in FIG. 9.

### DETAILED DESCRIPTION OF THE INVENTION

An organic EL display device according to a first embodiment of the present invention will now be described with reference to the accompanying drawings.

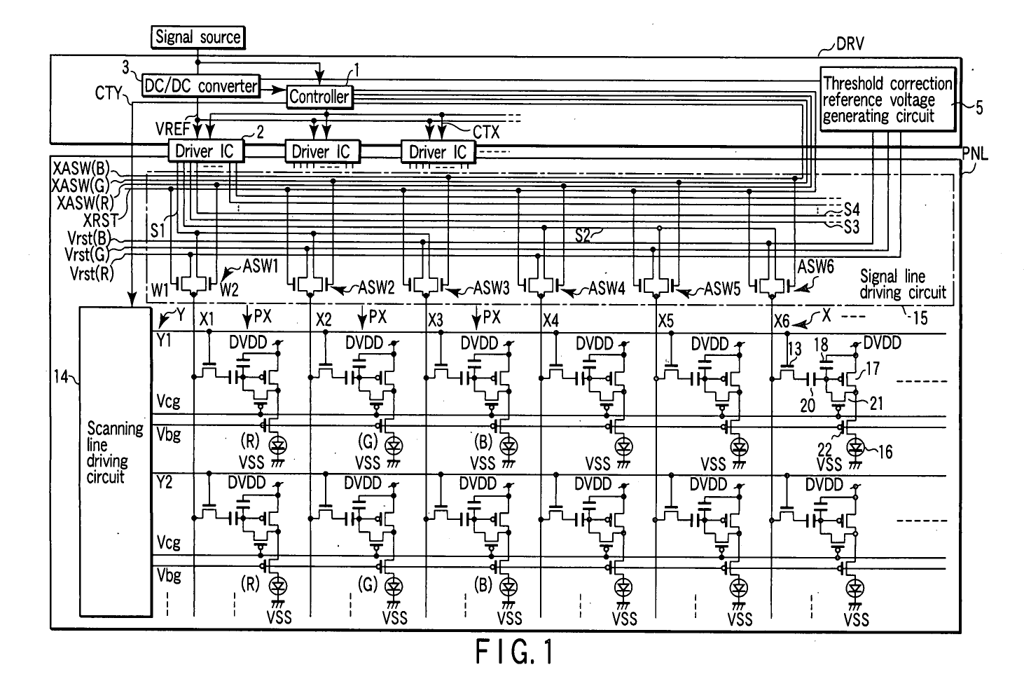

FIG. 1 shows the circuit configuration of the organic EL display device. The organic EL display device comprises an organic EL panel PNL and an external drive circuit DRV.

The external drive circuit DRV comprises a controller 1 that executes a digital process for driving the organic EL panel PNL on the basis of digital pixel video signals supplied from a signal source such as a personal computer, and on the basis of other data; a plurality of driver ICs 2 that convert the digital pixel video signals to analog pixel video signals; and a DC/DC converter 3 that generates power supply voltages for operating the controller 1, driver ICs 2 and organic EL panel PNL.

The organic EL panel PNL comprises an (m×n) number of pixels PX arrayed in a matrix on a light transmitting insulation substrate such as a glass plate; an m-number of scanning lines Y (Y1 to Ym) disposed along rows of the pixels PX; an n-number of signal lines X (X1 to Xn) disposed along columns of the pixels PX and perpendicularly intersecting the scanning lines Y; an (m×n) number of pixel switches 13 disposed near intersections of the scanning lines Y and signal lines X; a scanning line driving circuit 14 that sequentially drives the scanning lines Y1 to Ym; and a signal line driving circuit 15 that drives the signal lines X1 to Xn. Three adjacent pixels PX in the row direction serve as a single color pixel, and produce light with wavelengths of red, green and blue, respectively. The pixels PX located in the first column, fourth column, seventh column, . . . , are red pixels. The pixels PX located in the second column, fifth column, eighth column, . . . , are green pixels. The pixels PX located in the third column, sixth column, ninth column, . . . , are blue pixels. In the descriptions below, (R), (G) and (B) are added to reference symbols of some components for the red pixel, green pixel and blue pixel, respectively, so that the components can be distinguished.

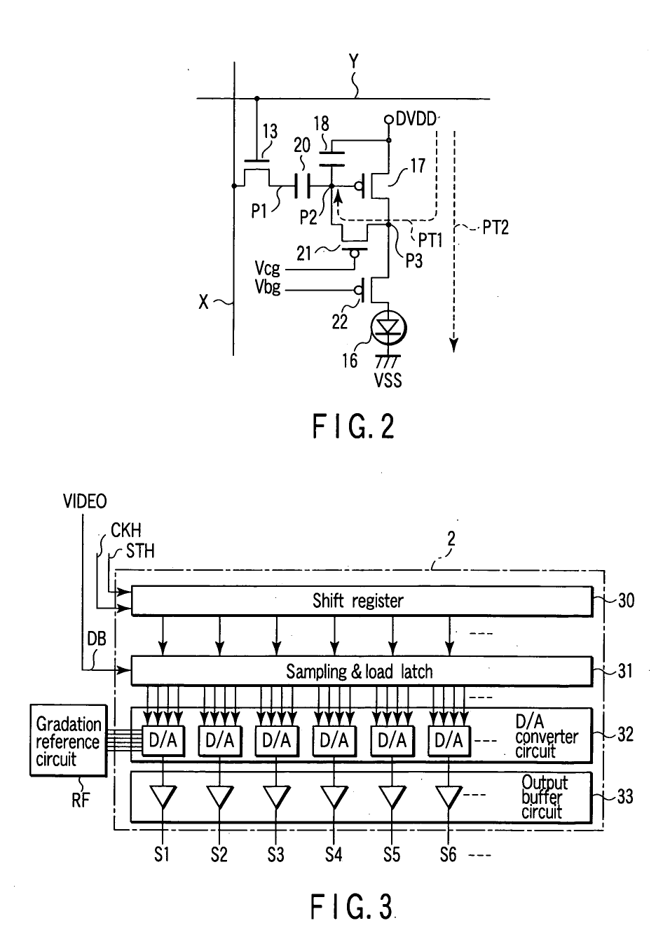

FIG. 2 shows an equivalent circuit of each pixel PX shown in FIG. 1. The pixel PX comprises an organic EL element 16 that is a self-luminous element, a drive control element 17 composed of, e.g. a P-channel thin-film transistor and connected in series with the organic EL element 16 between a pair of power lines DVDD and VSS, and a capacitance element 18 that stores an analog pixel video signal Vsig captured by the pixel switch 13 as a control voltage for the drive control element 17. The pixel switch 13 is composed of, e.g. an N-channel thin-film transistor, and is driven by a scanning signal Vscan from the scanning line Y to sample and hold the analog pixel video signal Vsig supplied to the signal line X for the associated pixel.

The analog pixel video signal Vsig captured in this manner by the pixel switch 13 is applied to the drive control element 17 as the control voltage. The drive control element 17 causes a drive current Ids to flow into the organic EL element 16 according to the pixel video signal Vsig. The organic EL element 16 is of a structure having a thin luminescent layer having a red, green, or blue luminescent organic compound and held between a cathode and an anode, so that electrons and holes are supplied and recombined in the luminescent layer to create excitons. The organic EL element 16 outputs light radiated during deactivation of the excitons.

The pixel PX includes a threshold cancel circuit in addition to the organic EL element 16, drive control element 17 and capacitance element 18.. The threshold cancel circuit includes a capacitor 20 connected between the drain of the pixel switch 13 and the gate of the drive control element 17, a first switch 21 for effecting threshold correction for the drive control element 17, and a second switch 22 for outputting the drain current of the drive control element 17 as drive current Ids to the organic EL element 16.

The external drive circuit DRV includes a threshold correction reference voltage generating circuit 5 for generating reset signals Vrst(R), Vrst(G) and Vrst(B) which are used as threshold correction reference voltages for the drive control elements 17 in the threshold cancel circuits of the red, green and blue pixels PX, respectively. The signal line driving circuit 15 includes an n-number of switch sections ASW1 to ASWn connected to the signal lines X1 to Xn. Each of the switch sections ASW1 to ASWn comprises a first analog switch W1 and a second analog switch W2. The first analog switch W1 outputs one of the reset signals Vrst(R), Vrst(G) and Vrst(B) supplied from the threshold correction reference voltage generating circuit,5 to a corresponding signal line X. The second analog switch W2 outputs the analog pixel video signal Vsig from a corresponding driver IC 2 to a corresponding signal line X.

The controller 1 sorts the digital pixel video signals for one row, which is supplied in every horizontal scanning period, into red pixel video signals, green pixel video signals and blue pixel video signals, so that these signals are output in a video write period for red pixels, a video write period for green pixels and a video write period for blue pixels, which are obtained by trisecting an effective video period in one horizontal scanning period. The controller 1 produces various control signals such as a vertical scan control signal CTY and a horizontal scan control signal CTX. The vertical scan control signal CTY includes a vertical start signal, which is a pulse generated in every vertical scanning period, and a vertical clock signal comprising pulses which are generated by a number equal to the number of scanning lines Y in every vertical scanning period. The horizontal scan control signal CTX includes a horizontal start signal STH, which is a pulse generated in every horizontal scanning period (1H); a horizontal clock signal CKH comprising pulses which are generated by a number equal to the number of signal lines X in every horizontal scanning-period; a reset mode signal XRST for controlling supply of reset signals to the signal lines X; and write mode signals XASW(R), XASW(G) and XASW(B) for controlling supply of pixel video signals to the signal lines X in the video write periods for the red pixels, green pixels and blue pixels. The vertical scan control signal CTY is supplied from the controller 1 to the scanning line driving circuit 14. The horizontal scan control signal CTX and digital pixel video signals VIDEO are supplied from the controller 1 to the driver ICs 2. The write mode signals XASW(R), XASW(G) and XASW(B) and reset mode signal XRST are supplied to the signal line driving circuit 15.

The scanning line driving circuit 14 shifts the vertical start signal in synchronism with the vertical clock signal, thereby sequentially selecting the scanning lines Y and supplying to the selected scanning line Y the scanning signal Vscan to effect a pixel select/non-select control. In the present embodiment, different rows of the pixels are sequentially selected in every horizontal scanning period. A reset control signal Vcg is supplied to electrically connect the drain and gate of the drive control element only in a reset time period in the horizontal scanning period, that is, only in an initializing period and a threshold cancel period. A reset control signal Vbg is set such that the second switch 22 is rendered conductive in the reset time period and light emission time period. The reset control signals Vcg and Vbg are supplied respectively to the first switch 21 and second switch 22 of each of the pixels PX in one row via supply lines disposed substantially parallel to the scanning lines Y.

In the signal line driving circuit 15, the analog switches W1 of the switch sections ASW1, ASW4, ASW7, . . . , are connected between the signal lines X1, X4, X7, . . . , connected to the red pixels, on the one hand, and the reset signal Vrst(R) output terminal of the threshold correction reference voltage generating circuit 5, on the other hand. The analog switches W1 of the switch sections ASW2, ASW5, ASW8, . . . , are connected between the signal lines X2, X5, X8, . . . , connected to the green pixels, on the one hand, and the reset signal Vrst(G) output terminal of the threshold correction reference voltage generating circuit 5, on the other hand. The analog switches W1 of the switch sections ASW3, ASW6, ASW9, . . . , are connected between the signal lines X3, X6, X9, . . . , connected to the blue pixels, on the one hand, and the reset signal Vrst(B) output terminal of the threshold correction reference voltage generating circuit 5, on the other hand. Besides, the analog switches W2 of the switch sections ASW1, ASW2 and ASW3 are connected between a first output terminal S1 of the associated driver IC 2 and the signal lines X1, X2 and X3. The analog switches W2 of the switch sections ASW4, ASW5 and ASW6 are connected between a second output terminal S2 of the associated driver IC 2 and the signal lines X4, X5 and X6. The analog switches W2 of the switch sections ASW7, ASW8 and ASW9 are connected between a third output terminal S3 of the associated driver IC 2 and the signal lines X7, X8 and X9. Similarly, the analog switches W2 of the other switch sections ASW10 to ASWn are connected between associated output terminals of the associated driver IC and associated triplets of signal lines X, that is, in units of a triplet of color pixels (red, green and blue pixels). The first analog switches W1 of the switch sections ASW1 to ASWn are rendered conductive by the control of the reset mode signal XRST. The second analog switches W2 of the switch sections ASW1, ASW4, ASW7, . . . , are rendered conductive by the control of the write mode signal XASW(R). The second analog switches W2 of the switch sections ASW2, ASW5, ASW8, . . . , are rendered conductive by the control of the write mode signal XASW(G). The second analog switches W2 of the switch sections ASW3, ASW6, ASW9, . . . , are rendered conductive by the control of the write mode signal XASW(B).

Each driver IC 2 is mounted on a flexible wiring film as a TAB-IC, and connected between an end portion of the wiring board of the external drive circuit DRV and an end portion of the organic EL panel PNL. As is shown in FIG. 3, the driver IC 2 includes a bus line DB that receives the digital pixel video signals VIDEO from the controller 1; a shift register 30 that shifts the horizontal start signal STH in synchronism with the horizontal clock signal CKH to control the serial-to-parallel-conversion timings for the digital pixel video signals; a sampling & load latch 31 that sequentially latches the digital pixel video signals VIDEO supplied to the bus line DB by the control of the shift register 30 and outputs the latched digital pixel video signals in parallel; a digital-to-analog (D/A) converter circuit 32 for converting the digital pixel video signals VIDEO to analog pixel video signals Vsig; and an output buffer circuit 33 for amplifying the analog pixel video signals Vsig obtained by the D/A converter circuit 32. The D/A converter circuit 32 is configured to refer to a predetermined number of gradation reference signals VREF (specifically, gradation reference voltages V0 to V9) generated-from a gradation reference circuit RF built in, for example, the DC/DC converter 3.

Specifically, the D/A converter circuit 32 comprises a plurality of D/A conversion sections known as resistor DACs. According to the digital pixel video signals VIDEO supplied from the sampling & load latch 31, each D/A conversion section selects one of the predetermined number of gradation reference signals VREF and resistor-divides the selected gradation reference signal VREF, thereby producing an analog pixel video signal Vsig. The output buffer circuit 33 comprises a plurality of buffer amplifiers that receive the analog pixel video signals Vsig from the D/A conversion sections and produce them from output terminals S1, S2, S3, . . . .

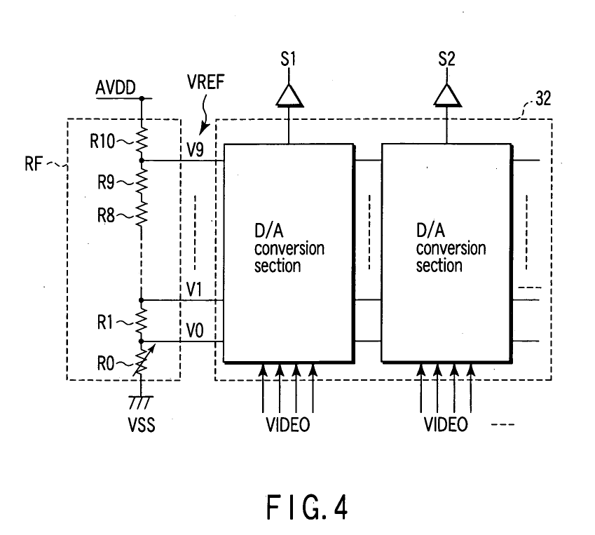

The gradation reference circuit RF, as shown in FIG. 4, comprises a variable resistor R0 and fixed resistors R1 to R10, which are connected in series. A reference power supply voltage between power lines AVDD and VSS is divided by the resistors R0 to R10, thereby producing a predetermined number of gradation reference signals VREF (gradation reference voltages V0 to V9) common to the red, green, and blue pixels PX.

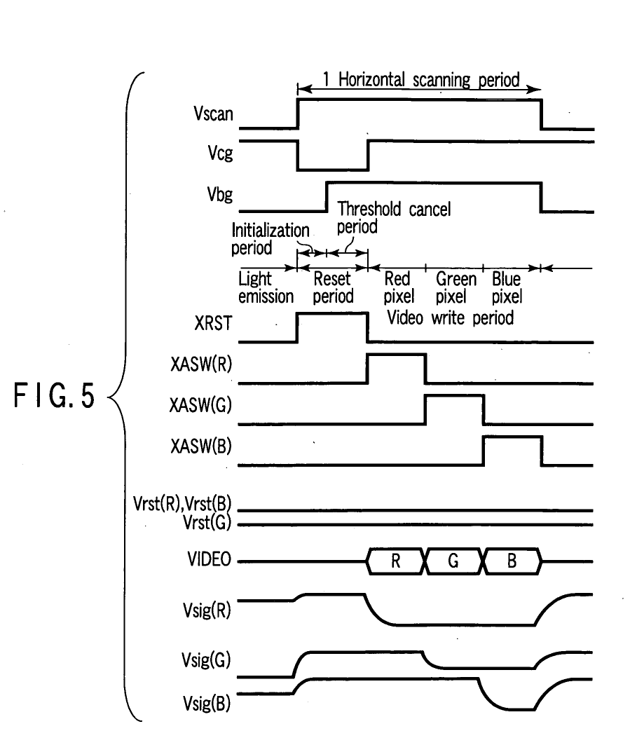

FIG. 5 shows signal waveforms generated during the operation of the organic EL display device shown in FIG. 1. If the scanning signal Vscan is supplied to one scanning line Y, the pixel switches 13 of the pixels PX in the row connected to this scanning line Y are turned on by the rising of the scanning signal Vscan. The reset mode signal XRST sets a reset time period of a predetermined length beginning from the rising of the scanning signal Vscan. In the reset time period, the analog switches W1 of the switch sections ASW1 to ASWn are turned on, and the reset signal Vrst(R) is supplied to the signal lines X1, X4, X7, . . . , the reset signal Vrst(G) to the signal lines X2, X5, X8, . . . , and the reset signal Vrst(B) to the signal lines X3, X6, X9, . . . .

In the initializing period in the reset time period, both the reset control signals Vcg and Vbg are set at low level. Consequently, the switch 21 and switch 22 of each pixel PX are turned on. A potential (potential at node P1) between the drain of the pixel switch 13 and one of the electrodes of the capacitor 20 is raised by the reset signal Vrst(R), Vrst(G) or Vrst(B) captured by the pixel switch 13. On the other hand, the gate potential (potential at node P2) of the drive control element 17 and the drain potential (potential at node P3) of the drive control element 17 fall due to a discharge current that flows via the switch 21.

In the subsequent threshold cancel period, the reset control signal Vbg rises to turn off the switch 22. Thereby, the potential at node P2 rises up to a level equal to the threshold voltage Vth of the drive control element 17 due to a charging current that flows along a path PT1 connecting the power line DVDD, switch 21 and node P2. On the other hand, the reset signal Vrst(R), Vrst(G) or Vrst(B) is held on the node P1 side of the capacitor 20.

Thereafter, the reset mode signal XRST falls to turn off the analog switches W1 of switch sections ASW1 to ASWn. Consequently, the supply of the reset signal Vrst(R), Vrst(G) or Vrst(B) is cut off. Then, the reset control signal. Vcg rises to turn off the-switch 21. Thus, the capacitor 20 stores the potential difference between the reset signal and the threshold voltage of the drive control element 17.

Then, the write mode signal XASW(R) rises to set a video write period for red pixels, which has a length corresponding to a ⅓ effective video period.

In this video write period for red pixels, the second analog switches W2 of the switch sections ASW1, ASW4, ASW7, . . . , supply to the signal lines X1, X4, X7, . . . , the analog red pixel video signals Vsig(R) obtained from the output terminals S1, S2, S3, . . . of the driver ICs 2. Hence, in each pixel PX serving as a red pixel, the potential at node P2 is set at a level obtained by adding the pixel video signal Vsig(R) to the threshold voltage Vth.

Succeeding the write mode signal XASW(R), the write mode signal XASW(G) in turn rises to set a video write period for green pixels, which has a length corresponding to a ⅓ effective video period.

In this video write period for green pixels, the second analog switches W2 of the switch sections ASW2, ASW5, ASW8, . . . , supply to the signal lines X2, X5, X8, . . . , the analog green pixel video signals Vsig(G) obtained from the output terminals S1, S2, S3, of the driver ICs 2. Hence, in each pixel PX serving as a green pixel, the potential at node P2 is set at a level obtained by adding the pixel video signal Vsig(G) to the threshold voltage Vth.

Then, succeeding the write mode signal XASW(G), the write mode signal XASW(B) in turn rises to set a video write period for blue pixels, which has a length corresponding to a ⅓ effective video period.

In this video write period for blue pixels, the second analog switches W2 of the switch sections ASW3, ASW6, ASW9, . . . , supply to the signal lines X3, X6, X9, . . . , the analog blue pixel video signals Vsig(B) obtained from the output terminals S1, S2, S3, . . . of the driver ICs 2. Hence, in each pixel PX serving as a blue pixel, the potential at node P2 is set at a level obtained by adding the pixel video signal Vsig(B) to the threshold voltage Vth.

At the end of the video write period for blue pixels, the reset control signal Vbg falls to turn on the switch 22. Thereby, a current IeL flows through a path PT2 connecting the power line DVDD, drive control element 17, switch 22, organic EL element 16 and power line VSS. The current IeL is equal to the drive current Ids that is the drain output of the drive control element 17 determined by the potential difference between the reset signal Vrst and pixel video signal Vsig.

More specifically, if the potential at node P2 is Va, the current IeL (=Ids) flowing in the organic EL element 16 is given by

$$\begin{matrix}IeL = Ids \\ = {α ( Vgs - Vth )}^{2} \\ = {α ( ( Va - DVDD ) - Vth )}^{2}\end{matrix} \qquad ( equation 1 )$$

where α is the constant determined by the size, etc. of the drive control element 17, Vgs is the gate-source voltage of the drive control element 17, Vth is the threshold voltage of the drive control element 17, and DVDD is the potential of the power line DVDD relative to the power line VSS. When the switch 21 is in the off state, the node P2 is in the floating state and the potential Va varies in accordance with a variation in potential of the node P1. If the varied potential at node P2 is Va′, equation 1 is expressed as follows:

$$\begin{matrix}IeL = {α ( ( {Va}^{′} - DVDD ) - Vth )}^{2} \\ = {α ( ( Va - ( Vsig - Vrst ) - DVDD ) - Vth )}^{2}\end{matrix} \qquad ( equation 2 )$$

After the threshold cancel operation (Ids=0), the potential Va is

Va=Vth+DVDD (equation 3)

Thus, if equation 3 is substituted in equation 2 with DVDD being set at a constant value,

IeL=α(Vsig−Vrst)² (equation 4)

Hence, it is understood that the current IeL depends on the pixel video signal Vsig and reset signal Vrst, irrespective of the transistor characteristic of the drive control element 17.

In the organic EL display device of this embodiment, the reset signals Vrst(R), Vrst(G) and Vrst(B), which are determined for the current-luminance characteristics of the red, green and blue organic EL elements 16, respectively, are generated. The reset signals Vrst(R), Vrst(G) and Vrst(B) are supplied to the associated pixels PX as threshold correction reference voltages for correcting the initialization level of the control voltage of the drive control elements 17. Specifically, the luminance balance between the red, green and blue organic EL elements 16 can be defined by the mutual relationship between the, reset signals Vrst(R), Vrst(G) and Vrst(B). Therefore, when the pixel video signals are D/A converted, it is possible to use a predetermined number of gradation reference voltages obtained from the gradation reference circuit RF provided commonly for the red, green and blue organic EL elements 16. Moreover, even if there is a variation in the threshold voltage Vth of each drive control element 17 due to the manufacturing process, the control voltage for the drive control element 17 is initialized to a level equal to the inherent threshold voltage Vth of the drive control element 17, prior to capturing the pixel video signal Vsig. Thereby, the organic EL elements 16 can be supplied with currents that cause the same luminance to be obtained for the same pixel video signal Vsig. Accordingly, the red, green and blue organic EL elements 16 within the color pixel can be driven to emit light with proper luminance, regardless of the variation in threshold voltage Vth. In this case, since the luminance balance between the red, green and blue organic EL elements 16 is not lost, a desired white chromaticity can be obtained. In addition, a desired white chromaticity can also be obtained by setting the transistor sizes of drive control elements 17 in accordance with the current-luminance characteristics of the red, green and blue organic EL elements 16, and also by using the reset signals Vrst(R), Vrst(G) and Vrst(B), thereby supplying the red, green and blue organic EL elements 16 with mutually different currents while maintaining the luminance balance for the same pixel video signal Vsig.

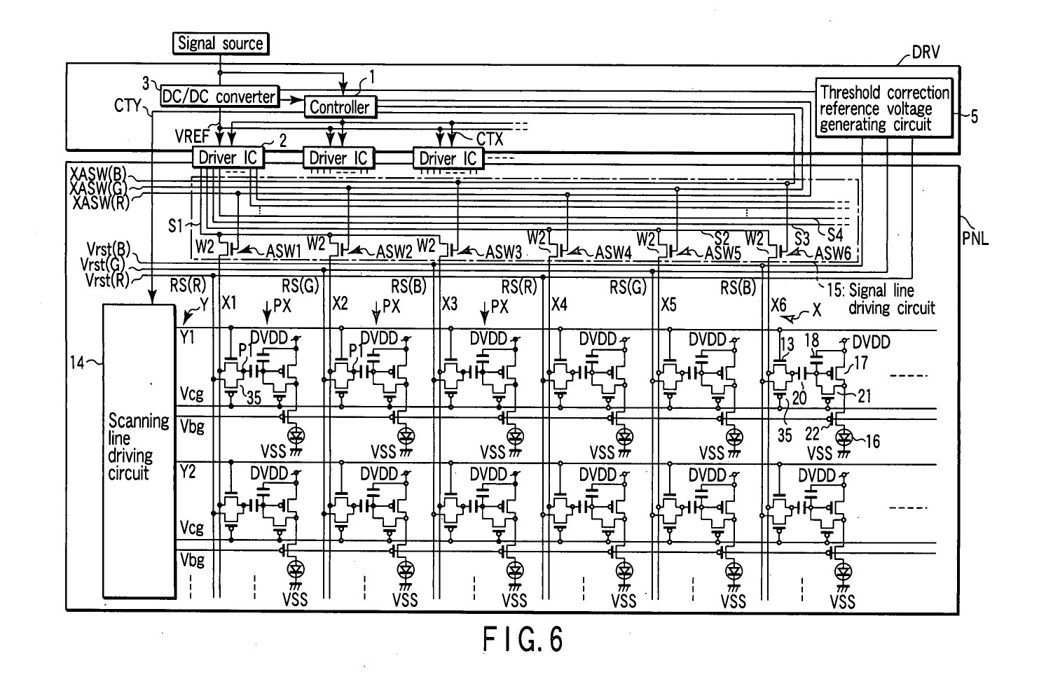

Next, an organic EL display device according to a second embodiment of the present invention will now be described with reference to FIG. 6. In the first embodiment, the same signal line is used to supply the pixel video signal and reset signal. Alternatively, as shown in FIG. 6, different lines may be used to individually supply the pixel video signal and reset signal. This ensures a sufficient reset time even where the display area or display density of the display device is increased, and also this prevents non-uniformity in display due to an increase in the number of pixels.

The organic EL display device of the second embodiment has the same advantageous effect as that of the first embodiment. Specifically, a plurality of reset switches 35 are connected to the reset signal Vrst(R) output terminal, reset signal Vrst(G) output terminal and reset signal Vrst(B) output terminal of the threshold correction reference voltage generating circuit 5 via reset signal lines RS(R), RS(G) and RS(B) disposed along columns of pixels PX. Reset signals Vrst(R), Vrst(G) and Vrst(B) are supplied to the reset switches 35 from the reset signal Vrst(R) output terminal, reset signal Vrst(G) output terminal and reset signal Vrst(B) output terminal, and are captured by the reset switches 35. The reset signal Vrst(R) output terminal, reset signal Vrst(G) output terminal and reset signal Vrst(B) output terminal need not be changed from the potentials of the reset signals Vrst(R), Vrst(G) and Vrst(B). The same applies to the reset signal lines RS(R), RS(G) and RS(B) connecting the reset signal Vrst(R) output terminal, reset signal Vrst(G) output terminal and reset signal Vrst(B) output terminal and the reset switches 35. Therefore, the reset switches 35 can quickly capture the reset signals Vrst(R), Vrst(G) and Vrst(B), without being affected by the wiring capacitance parasitic on the reset signal lines RS(R), RS(G) and RS(B). In other words, when the reset signal Vrst(R), Vrst(G) or Vrst(B) are supplied via the signal lines X for supplying the pixel video signals Vsig, a signal transition time may become deficient. However, such a situation hardly occurs that the control voltage of the drive control element 17 cannot completely be initialized due to such a deficient signal transition time. Hence, even in the case where the wiring capacitance has increased, non-uniformity in display depending on the threshold voltage Vth of the drive control element 17 can surely be prevented.

The reset switches 35 are connected to the reset signal Vrst(R) output terminal, reset signal Vrst(G) output terminal and reset signal Vrst(B) output terminal of the threshold correction reference voltage generating circuit 5 via the reset signal lines RS(R), RS(G) and RS(B) disposed along the columns of pixels PX. Although the reset signal lines RS(R), RS(G) and RS(B) can be disposed along the rows of pixels PX, it is necessary, in this case, to provide each row with three reset signal lines, or to use a common line and perform time-division of the reset time period. This leads to an increase in the number of wires and to complex circuitry. By contrast, in the above-described structure in which the reset signal lines RS(R), RS(G) and RS(B) are disposed along the columns of pixels PX, the current at the time of reset is distributed to all the reset signal lines RS(R), RS(G) and RS(B). In other words, a voltage drop occurring in each of the reset signal lines RS(R), RS(G) and RS(B) is reduced to a value calculated by dividing the voltage drop by the number of reset signal lines. Thus, crosstalk occurring between the pixels PX in one row due to the voltage drop can be improved, compared to the case where the reset signal lines RS(R), RS(G) and RS(B) are disposed along the rows of pixels PX, and a uniform image can be displayed on the display screen.

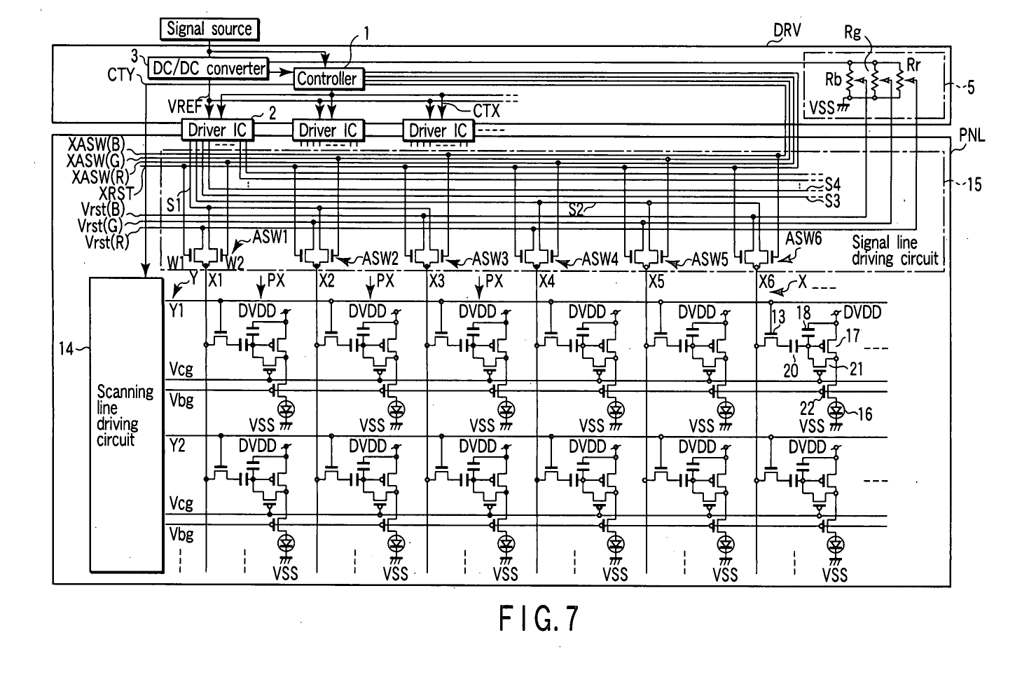

An organic EL display device according to a third embodiment of the present invention will now be described with reference to FIG. 7.

The threshold correction reference voltage generating circuit 5 in the first and second embodiments may be configured as shown in FIG. 7, such that the voltages of the reset signals Vrst(R), Vrst(G) and Vrst(B) are independently variable. The threshold correction reference voltage generating circuit 5 includes variable resistors Rr, Rg and Rb which divide the power supply voltage from the DC/DC converter 3. Intermediate taps of the variable resistors Rr, Rg and Rb are used as the reset signal Vrst(R) output terminal, reset signal Vrst(G) output terminal and reset signal Vrst(B) output terminal, respectively.

Since the voltages of the reset signals Vrst(R), Vrst(G) and Vrst(B) are variable, even if a variation of the current-luminance characteristic or chromaticity due to the manufacturing process occurs in the organic EL elements 16 of each emission color, a desired white chromaticity can be obtained. More specifically, as is clear from the above-described equation 4, the current IeL increases and decreases in accordance with the potential difference between the pixel video signal Vsig and reset signal Vrst. Thus, the reset signals Vrst(R), Vrst(G) and Vrst(B) are independently set such that different currents IeL are supplied to the red, green and blue organic EL elements 16 for the same pixel video signal, thereby adjusting the luminance balance.

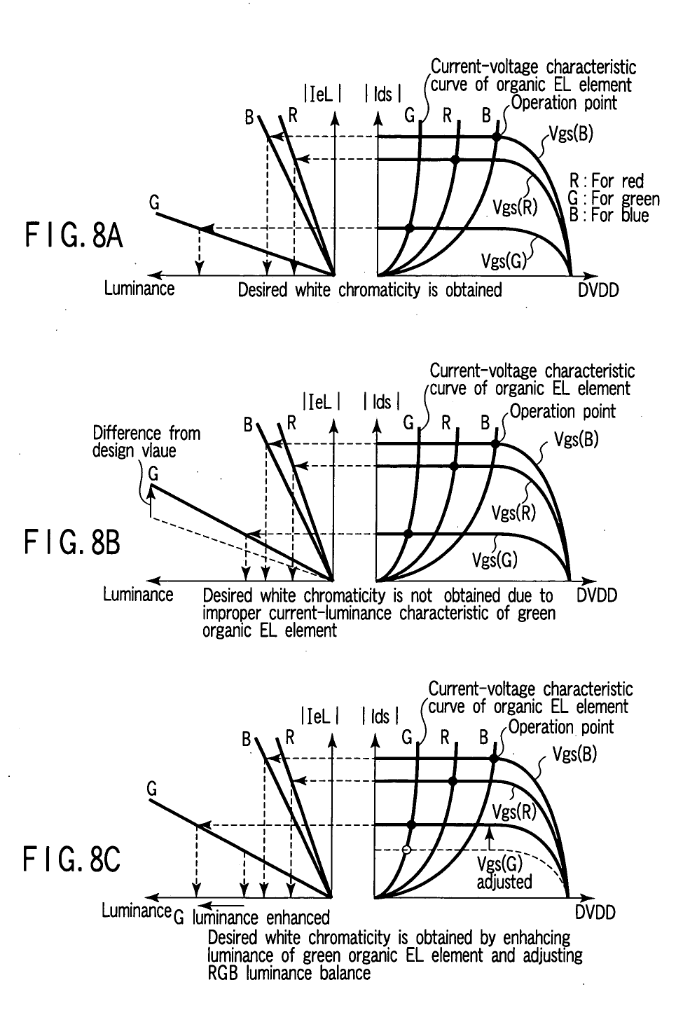

A specific example of adjustment of the luminance balance will now be described referring to FIGS. 8A to 8C. FIG. 8A shows a state in which the desired white chromaticity is obtained by the proper current-luminance characteristics of the red, green and blue organic EL elements 16 that accord with the designed ones. FIG. 8B shows a state in which the desired white chromaticity is not obtained due to the improper current-luminance characteristics of the red, green and blue organic EL elements 16 that fail to accord with the designed ones. In the state shown in FIG. 8B, the luminance of the green organic EL element 16 is lower, relative to the same drive current Ids as in FIG. 8A. To cope with this problem, the voltage Vgs is raised to increase the luminance up to the same level as in FIG. 8A. The voltage Vgs can be raised by increasing the amount of change in the potential at node P2, that is, the potential difference between the pixel video signal Vsig and reset signal Vrst. In this case, since the pixel video signal Vsig is fixedly set by the driver IC 2, the reset signal Vrst(G) is increased. Thus, as shown in FIG. 8C, the reset signal Vrst(G) is set so as to properly increase the luminance of the green organic EL element 16 on the basis of the current-luminance characteristic. Thereby, the luminance balance between the red, green and blue organic EL elements 16 is adjusted, and the desired white chromaticity can be obtained without a deterioration due to a difference from the design value of the current-luminance characteristic of the green organic EL element 16.

In the above example of adjustment, only the current-luminance characteristic of the green organic EL element 16 fails to accord with the designed one. The threshold correction reference voltage generating circuit 5 varies the reset signals Vrst(R), Vrst(G) and Vrst(B) independently. Thus, even where the current-luminance characteristic fails to accord with the designed one in any of, or a combination of the red, green and-blue organic EL elements 16, the voltages of the reset signals Vrst(R), Vrst(G) and Vrst(B) can properly be varied to achieve the desired white chromaticity. Moreover, even where the individual chromaticities of R, G and B are different from the design values, the voltages of the reset signals Vrst(R), Vrst(G) and Vrst(B) can properly be varied to correct the RGB luminance balance and to achieve the desired white chromaticity. In this case, the desired white chromaticity is obtained with the RGB luminance balance that is different from the RGB luminance balance shown in FIG. 8A.

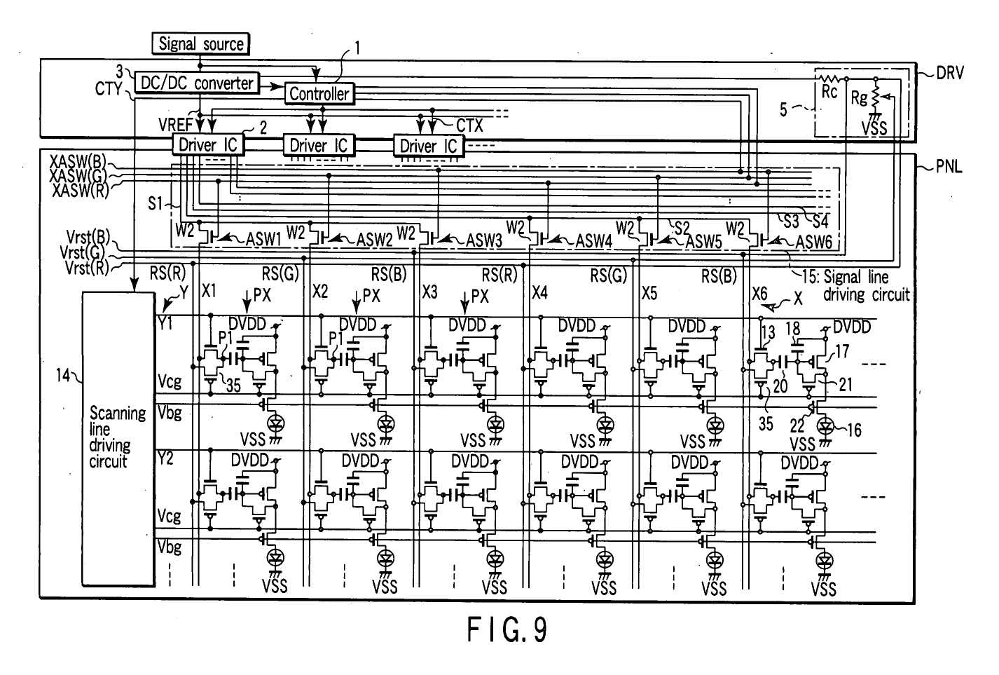

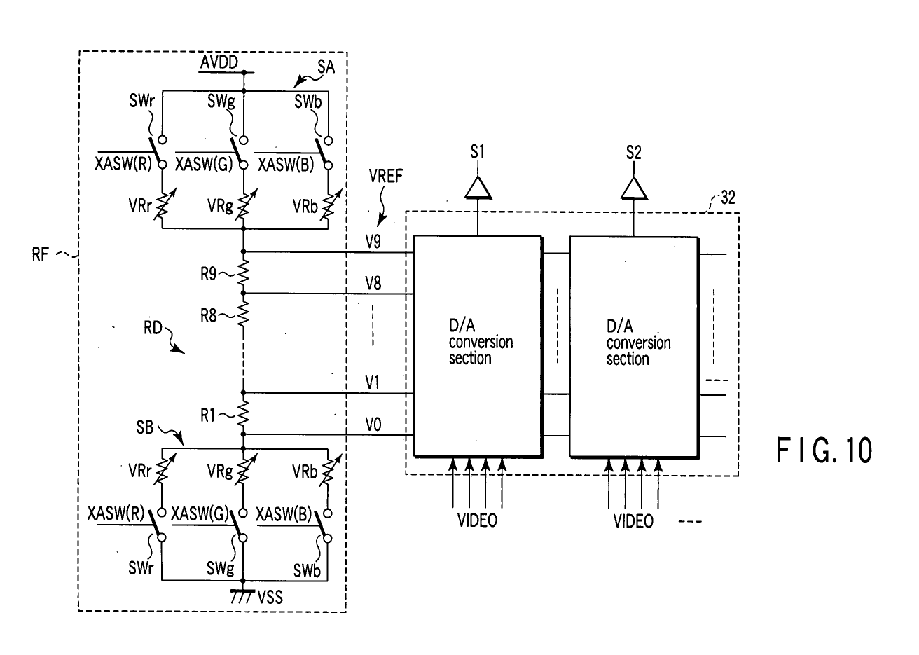

An organic EL display device according to a fourth embodiment of the present invention will now be described with reference to FIGS. 9 and 10.

Regarding the first and second embodiments, fixed potentials are output as the reset signals for different emission colors in the threshold correction reference voltage generating circuit 5. Regarding the third embodiment, independently-variable potentials are output as the reset signals for different emission colors in the threshold correction reference voltage generating circuit 5. Alternatively, as shown in FIG. 9, the threshold correction reference voltage generating circuit 5 may be configured such that fixed potentials are output as the reset signals Vrst(R) and Vrst(B) and an independently-variable potential is output as the reset signal Vrst(G). That is, the threshold correction reference voltage generating circuit 5 shown in FIG. 9 includes a series circuit of a fixed resistor Rc and a variable register Rg, which divides the power supply voltage from the DC/DC converter 3. A node connected between the resistor Rc and resistor Rg is used as the reset signal Vrst(R) output terminal and the reset signal Vrst(B) output terminal. An intermediate tap of the variable resistor Rg is used as the reset signal Vrst(G) output terminal.

The fourth embodiment also differs from the second embodiment in that the gradation reference circuit RF is configured as shown in FIG. 10. The gradation reference circuit RF includes a ladder resistor RD and resistor switching circuits SA and SB. The resistor switching circuits SA and SB are connected at one end to the power lines AVDD and VSS, and the ladder resistor RD is connected between the other end of the resistor switching circuit SA and the other end of the resistor switching circuit SB. Each of the resistor switching circuits SA and SB includes a series circuit of a variable resistor VRr and change-over switch SWr, a series circuit of a variable resistor VRg and change-over switch SWg, and a series circuit of a variable resistor VRb and change-over switch SWb. These series circuits are connected in parallel to each other. In each of the resistor switching circuit SA and SB, the change-over switches SWr, SWg and SWb are turned on one by one under the control of the write mode signals XASW(R), XASW(G) and XASW(B) produced from the controller 1. The ladder resistor RD comprises fixed resistors R1 to R9 connected in series.

When the change-over switches SWr are turned on, the reference power supply voltage between the power lines AVDD and VSS is divided by the variable resistors VRr in the resistor switching circuits SA and SB and the fixed resistors R1 to R9 in the ladder resistor RD, thereby generating a predetermined number of red gradation reference signals VREF (gradation reference voltages V0 to V9). When the change-over switches SWg are turned on, the-reference power supply voltage between the power lines AVDD and VSS is divided by the variable resistors VRg in the resistor switching circuits SA and SB and the fixed resistors R1 to R9 in the ladder resistor RD, thereby generating a predetermined number of green gradation reference signals VREF (gradation reference voltages V0 to V9). When the change-over switches SWb are turned on, the reference power supply voltage between the power lines AVDD and VSS is divided by the variable resistors VRb in the resistor switching circuits SA and SB and the fixed resistors R1 to R9 in the ladder resistor RD, thereby generating a predetermined number of blue gradation reference signals VREF (gradation reference voltages V0 to V9).

In this organic EL display device, a design luminance balance between the red, green and blue pixels can be preset in the gradation reference circuit RF, and the current-luminance characteristic of the green organic EL element 16 can be adjusted with respect to the current-luminance characteristics of the red and blue organic EL elements 16 so as to correct an imbalance in luminance occurred due to the manufacturing process.

The present invention is not limited to the above-described embodiments, and various modifications can be made without departing from the spirit of the invention.

For example, in the above-described embodiments, self-luminous elements are formed on a light transmitting insulation substrate. However, such a light transmitting property is required if the substrate is located on a display-surface-side.

In the embodiments described above, for example, each driver IC 2 is mounted on the flexible wiring film as a TAB-IC. Alternatively, each driver IC 2 may be disposed on the circuit board of the external drive circuit DRV. Besides, a circuit functioning like the driver IC 2 may be integrally formed on the organic EL panel PNL.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display device comprising:
an array section having a plurality of pixels arrayed in a matrix, each pixel including a luminous element, a drive control element that causes a current to flow in said luminous element according to a pixel video signal, a capacitor, which is connected to a control terminal of said drive control element, and that temporarily stores the potential difference between the threshold voltage of said drive control element and a reset signal, and a pixel switch connected via said capacitor to the control terminal of the drive control element; and
a reset signal supply section that supplies to the pixels different reset signals associated with the main wavelengths of light to be emitted from the luminous elements.

2. The display device according to claim 1, wherein the reset signal supply section is configured to output an independently-variable potential as at least one of the reset signals.

3. The display device according to claim 1, wherein said pixel includes a reset switch that causes the reset signal to be supplied to said capacitor.

4. The display device according to claim 1, wherein individual wiring-lines are disposed to supply the reset signals to the pixels for the respective main wavelengths.

5. A method of driving a display device having a plurality of pixels, each pixel including a luminous element, a drive control element connected in series with said luminous element and a pixel switch connected via a capacitor to a control terminal of said-drive control element, comprising:
applying a potential equal to the threshold voltage of said drive control element to one of electrodes of said capacitor;
supplying to the other electrode of said capacitor a reset signal associated with the main wavelength of light to be emitted from said luminous element; and
supplying a pixel video signal to the other electrode of said capacitor via said pixel switch in a state where said capacitor stores the potential difference between the reset signal and the threshold voltage.
